(19) United States
(12) Patent Application Publication
(10) Pub. No.: US 2025/0157464 A1
(43) Pub. Date: May 15, 2025

(54) TOWARDS END-TO-END SPEECH-INPUT CONVERSATIONAL LARGE LANGUAGE MODELS

(71) Applicant: META PLATFORMS, INC., Menlo Park, CA (US)

(72) Inventors: Chunyang Wu, Sunnyvale, CA (US); Yassir Fathullah, Menlo Park, CA (US); Jay Kiran Mahadeokar, Fremont, CA (US); Egor Lakomkin, Aachen (DE); Ozlem Kalinli Akbacak, Los Altos, CA (US); Christian Fuegen, Kingston Upon Thames (GB); Michael Lewis Seltzer, Seattle, WA (US)

(21) Appl. No.: 18/940,817

(22) Filed: Nov. 7, 2024

Related U.S. Application Data
(60) Provisional application No. 63/597,440, filed on Nov. 9, 2023.

(51) Int. Cl. G10L 15/183; G10L 15/02; G10L 15/22

(52) U.S. Cl. CPC G10L 15/183; G10L 15/02; G10L 15/22

(57) ABSTRACT

The present application is at least directed to a method including a step of receiving audio from a user. The method may further include a step of generating, via a trained encoder based upon the received audio, an audio embedding sequence. The method may even further include a step of receiving, via a trained large language model (LLM), the generated audio embedding sequence and a text embedding sequence. The text embedding sequence is arranged before or after the generated audio embedding sequence. The method may yet even further include a step of producing, via the trained LLM based upon text embedding sequence, a textual response associated with the audio received from the user. The method may still even further include a step of causing to display, via a user interface of the user, the produced textual response.

### CROSS-REFERENCE TO RELATED APPLICATIONS

The instant application claims the benefit of priority of U.S. Provisional application No. 63/597,440 filed Nov. 9, 2023 entitled, “Towards End-to-End Speech-Input Conversational Large Language Models” the content of which is incorporated by reference in its entirety.

### FIELD

The present disclosure generally relates to systems and methods employing encoders and large language model to facilitate end-to-end speech processing.

### BACKGROUND

Speech recognition systems generally process received audio and convert the speech from the audio to a transcription. The transcription may include a text question. The text question may be transmitted to a large language model (LLM) to output a response. Current systems with LLMs cannot directly process audio input without converting it to text.

Standard LLMs may often produce outputs that are not aligned with user preference. In other words, the LLM may be subject to hallucinations exhibiting non-factual, unhelpful or toxic material.

### SUMMARY OF THE INVENTION

One aspect of the subject technology is directed to a method. The method may also include a step of receiving audio from a user. The method may further include a step of generating, via a trained encoder based upon the received audio, an audio embedding sequence. The method may even further include a step of receiving, via a trained LLM, the generated audio embedding sequence and a text embedding sequence. The text embedding sequence is arranged before or after the generated audio embedding sequence. The method may yet even further include a step of producing, via the trained LLM based upon text embedding sequence, a textual response associated with the audio received from the user. The method may still even further include a step of causing to display, via a user interface of the user, the produced textual response.

Another aspect of the subject technology is directed to a system including a non-transitory memory including instructions. The system may also include a processor configured to execute the instructions. One of the instructions includes receiving audio from a user. Another one of the instructions includes generating, via a trained encoder based upon the received audio, an audio embedding sequence. Yet another one of the instructions includes receiving, via a trained LLM, the generated audio embedding sequence and a text embedding sequence. The text embedding sequence is arranged before or after the generated audio embedding sequence. A further one of the instructions includes producing, via the trained LLM based upon the text embedding sequence, a textual response associated with the audio received from the user. Yet even a further one of the instructions includes causing to display, via a user interface of the user, the produced textual response.

In yet another aspect of the subject technology, a computer program product is provided. The computer program product may include at least one non-transitory computer-readable medium including computer-executable program code instructions stored therein. The computer-executable program code instructions may include program code instructions configured to receive audio from a user. The computer-executable program code instructions may include program code instructions configured to generate, via a trained audio encoder based upon the received audio, an audio embedding sequence. The computer-executable program code instructions may include program code instructions configured to receive, via a trained LLM, the generated audio embedding sequence and a text embedding sequence. The text embedding sequence may be arranged before or after the generated audio embedding sequence. The computer-executable program code instructions may include program code instructions configured to produce, via the trained LLM based upon the text embedding sequence, a textual response associated with the audio received from the user. The computer-executable program code instructions may include program code instructions configured to cause to display, via a user interface of the user, the produced textual response.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates a diagram of an exemplary network environment in accordance with one or more example aspects of the subject technology.

FIG. 2 illustrates a diagram of an exemplary communication device in accordance with one or more example aspects of the subject technology.

FIG. 3 illustrates an exemplary computing system in accordance with one or more example aspects of the subject technology.

FIG. 4 illustrates a machine learning and training model framework in accordance with example aspects of the present disclosure.

FIG. 5 illustrates a cascaded architecture to understand speech in accordance with one or more example aspects the subject technology.

FIGS. 6A-6B illustrate end-to-end (E2E) speech understanding in accordance with one or more example aspects of the subject technology.

FIG. 7 illustrates a large langue model (LLM) prompted with speech recognition capabilities in accordance with one or more example aspects the subject technology.

FIG. 8 illustrates a LLM architecture with audio chat features in accordance with an example aspect of the subject technology.

FIG. 9A illustrates in accordance with an example aspect of the subject technology.

FIG. 9B illustrates in accordance with an example aspect of the subject technology.

FIG. 10 illustrates a multi-turn dialog example using text and audio questions in accordance with one or more example aspects of the subject technology.

FIG. 11 illustrates an example of cosine similarity between text and audio embeddings in accordance with an example of the subject technology.

FIG. 12 illustrates an example flowchart in accordance with one or more example aspects of the subject technology.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

According to an aspect of the subject technology disclosed in the instant application, a system may include a trained encoder and a trained large language model (LLM) with end-to-end (E2E) speech processing and reasoning abilities. The LLM may utilize audio prompts instead of only text prompts and sustain a conversation in an E2E manner. The LLM is configured to perform speech recognition, speech translation, and audio summarization via dissemination of textual instructions prior to receiving an audio prompt. Additionally, the system is configured to sufficiently recognize difficult or rare words based upon advance instructions to guide the system in various recognition and reasoning tasks.

Audio has the capacity to encapsulate a diverse array of emotions within a person's speech. Images have the ability to depict structures and placement of objects. Both are significantly complex to convey through text.

One technical solution of the subject technology is the ability for the system to be prompted with audio as a direct replacement for text and allow a user to use speech to converse. To achieve this, the system may include an instruction-tuned LLM with speech-processing and reasoning capabilities. Second, the system may utilize existing datasets for speech-to-text conversational data in the (audio, text response) format. That is, new datasets are not required to operate the subject technology. The overall result is an end-to-end model that may perform text/speech-to-response generation and utilize prior context in a conversation to guide the model in its reasoning.

### Exemplary System Architecture

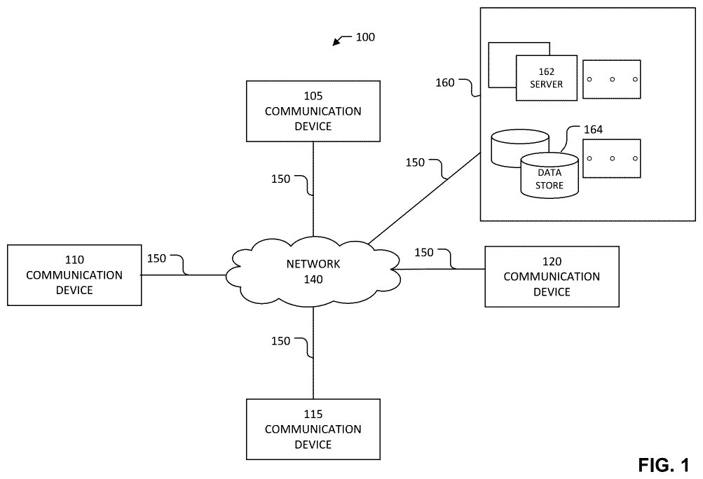

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140. In other examples, the network 140 may be any suitable network capable of provisioning content and/or facilitating communications among entities within, or associated with the network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

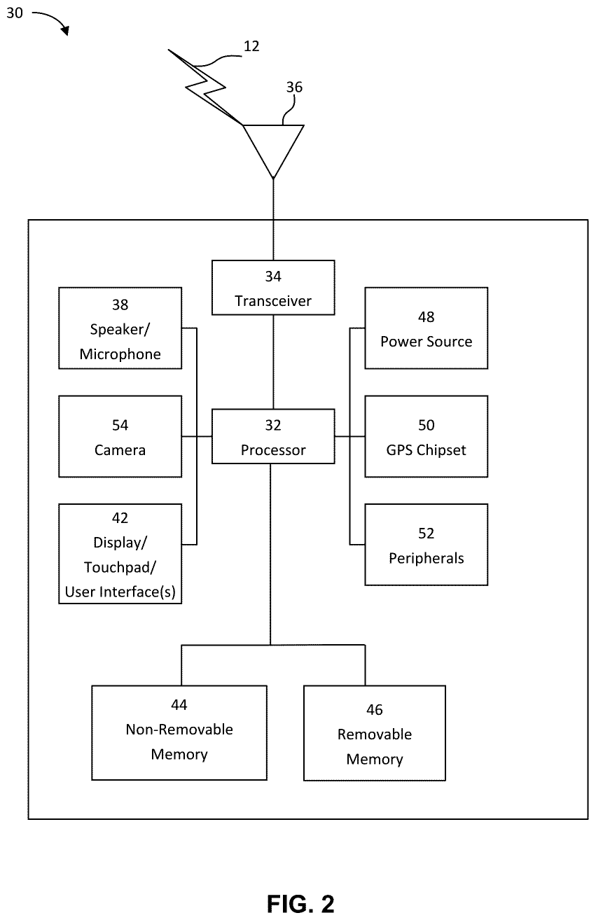

FIG. 2 illustrates a block diagram of an exemplary hardware/software architecture of a communication device such as, for example, user equipment (UE) 30. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

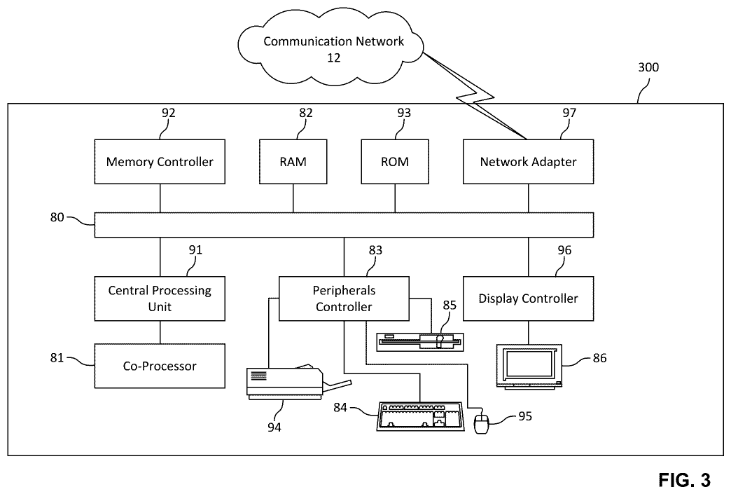

FIG. 3 is a block diagram of an exemplary computing system 300. In some exemplary embodiments, the network device 160 may be a computing system 300. The computing system 300 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adapter 97, that may be used to connect computing system 300 to an external communications network, such as network 12 of FIG. 2, to enable the computing system 300 to communicate with other nodes (e.g., UE 30) of the network.

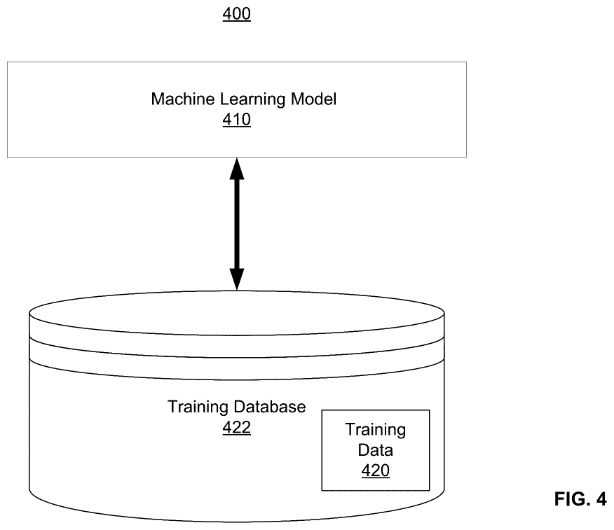

FIG. 4 illustrates a machine learning and training model, in accordance with an example of the present disclosure. The machine learning framework 400 associated with the machine learning model may be hosted remotely. Alternatively, the machine learning framework 400 may reside within a server 162 shown in FIG. 1, or be processed by an electronic device (e.g., head mounted displays, smartphones, tablets, smartwatches, or any electronic device, such as communication device 105). The machine learning model 410 may be communicatively coupled to the stored training data 420 in a memory or database (e.g., ROM, RAM) such as training database 422. In some examples, the machine learning model 410 may be associated with operations of any one or more of the systems/architectures depicted in subsequent figures of the application. In some other examples, the machine learning model 410 may be associated with other operations. The machine learning model 410 may be implemented by one or more machine learning models(s) and/or another device (e.g., a server and/or a computing system). In some embodiments, the machine learning model 410 may be a student model trained by a teacher model, and the teacher model may be included in the training database 422.

### Speech Architecture

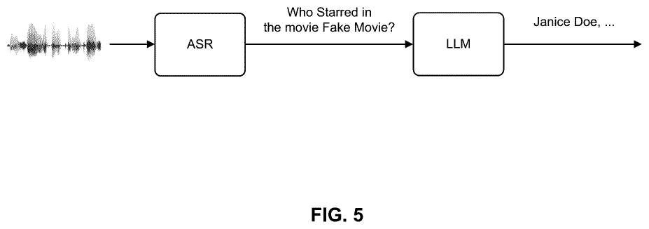

FIG. 5 depicts a cascaded architecture 500 for speech understanding according to the subject technology. Speech is sent to an automatic speech recognition (ASR) software to transcribe the speech (e.g., “Who starred in the movie Fake Movie?”). The movie named Fake Movie herein is fictitious for purposes of illustration. The transcription is subsequently fed into an LLM with chat capabilities to generate a response (e.g., Janice Doe, . . . (e.g. a fictitious person)). The transcription decision is made upstream which may impact the error rate downstream in the process.

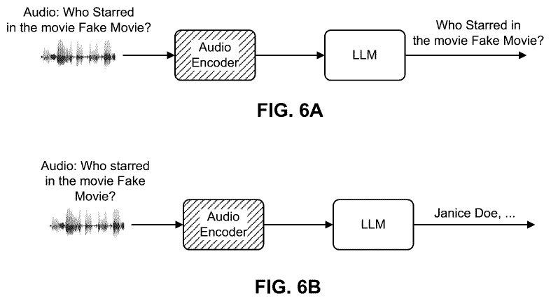

FIGS. 6A-6B illustrate end-to-end (E2E) speech understanding architectures 600, 650, respectively in accordance with the subject technology. Contrary to employing an ASR in FIG. 5, FIGS. 6A-6B deploy an audio encoder to postpone when the LLM is required to make a decision. The LLM may remain frozen. In an example embodiment as shown in architecture 600 in FIG. 6A, a combination of an LLM and audio encoder may be configured to operate like an ASR. In an alternative example embodiment as shown in architecture 650 in FIG. 6B, transcription may be skipped whereby an output of the audio encoder is sent to a LLM for processing. These embodiments may potentially reduce cascading errors and latency.

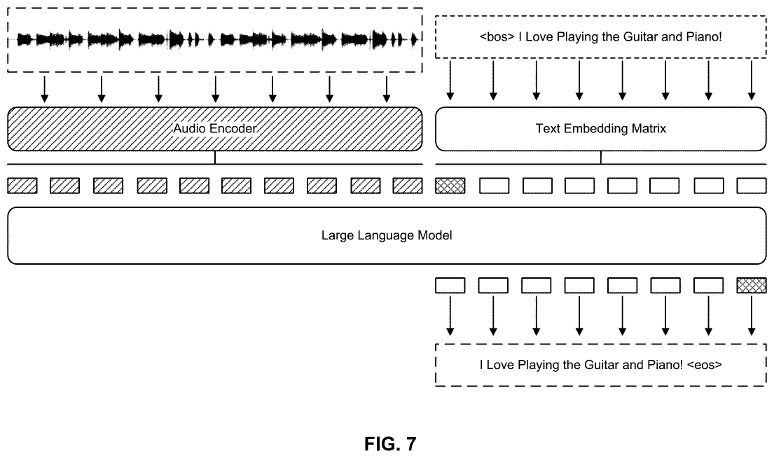

FIG. 7 illustrates an architecture 700 where a LLM is prompted with speech recognition capabilities, e.g., ASR, in accordance with one or more example aspects the subject technology. Here, a trained audio encoder 730 receives audio 710. The audio may be a recording or may be received in real-time. The audio encoder 730 is configured to generate an embedding sequence 735. As shown in FIG. 7, the audio embedding sequence 735 may include plural bits. The plural bits of the audio embedding sequence may be prepended to a text embedding sequence 745 including plural bits. The text embedding sequence 745 is generated by a text embedding matrix 740 based upon received text 720. Both the audio and text embedding sequences may be directly fed to a LLM 750. The LLM may be a decoder tasked with predicting a first or subsequent reply.

The audio encoder 730 may be a conformer-based audio encoder. The audio encoder 730 may be trained with a Connectionist Temporal Classification (CTC) loss. Outputs may be stacked and projected to the dimension of the LLM to ensure compatibility (e.g., alignment). The test frame rates may range from 80 ms to 960 ms typically.

The LLM 750 may be adapted with parameter efficient approaches 760, such as LoRA. The LLM may generate an output 770 (e.g., “I love playing the Guitar and Piano!”) based upon the audio and text embedding sequences.

### Speech Conversational Language Model

According to yet another aspect of the subject technology disclosed in the present application, the architecture may include a LLM configured as a decoder. It is envisaged according to the subject technology for the system to be prompted with audio as a direct replacement for text. The system may allow a user to freely have a conversation with the system. It is envisaged for all existing LLM capabilities to be preserved.

According to embodiment of this aspect, a multi-modal LLM-audio and text—may be operated in an identical manner as a unimodal LLM. That is, the LLM may consume a sequence of embeddings irrespective of modality and generate a textual response in an autoregressive manner. The audio encoder may use connectionist temporal classification. The audio encoder may be a pre-trained conformer encoder. The audio encoder may be configured to control audio resolution in a downsampling layer. For example, downsampling may be employed set to reduce the audio resolution and/or audio sequence length. The audio encoder may also be configured to ensure the audio embedding dimension matches (e.g., alignment) the LLM.

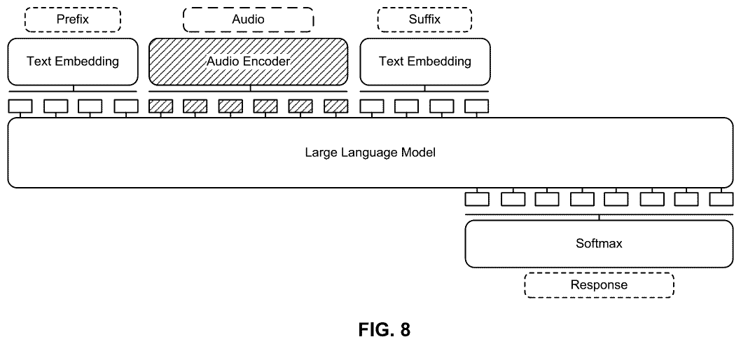

According to an embodiment, FIG. 8 illustrates an architecture 800 with an audio chat LLM 870 which may listen, understand, and respond. Examples may utilize audio prompts 820 and sustain a conversation, extending cross-modal capabilities such as spoken question answering (QA), speech translation, audio summarization, and multi-turn dialogue by utilizing prior conversational context. This model may interchange text modalities (e.g., text embeddings 840, 860) and audio modalities (e.g., audio encoder 850), allowing a user to have a conversation while maintaining the original LLM capabilities. The LLM 870 may consume a sequence of embeddings irrespective of the modality and does not differentiate between them. Additionally, the LLM 870 may generate a textual response 890 in an autoregressive manner 880.

In an further example embodiment of this aspect, a LLM chat model may be instruction-tuned for dialog and Question/Answer (Q/A). The LLM generally remains frozen to extend cross-modal capabilities (e.g., text and audio). This enables it to perform tasks such as spoken question answering (Q/A), speech translation, and audio summarization. Unlike cascades, the instant aspect may interchange text and audio modalities and utilize prior context in a conversation to provide improved results. Variable-length and continuous audio embeddings are sandwiched between prefixes and suffixes containing instructions for interpreting the audio prompt 1120. In some embodiments, the prefix and/or suffix may include a conversation history with a particular user.

The end-to-end model extends its capabilities with general-purpose speech processing (e.g., prefix processing 810 and suffix processing 830) and reasoning abilities, while maintaining the wide range of original LLM capabilities without using carefully curated paired data. The model may utilize audio prompts 820 (e.g., user audio) as a replacement for text in order to sustain a conversation with extended cross-modal capabilities.

The LLM 870 may consume a sequence of embeddings irrespective of the modality and may not differentiate between them. Variable-length and continuous audio embeddings are sandwiched between prefixes 810 and suffixes 820 containing instructions and potentially conversation history for interpreting the audio prompt 820. For text-based prompts, the audio encoder 850 is swapped out for the text embedding 840 and 860. As described previously in the application, the audio encoder 850 may include a connectionist temporal classification (CTC) pre-trained conformer encoder, followed by a projection layer to ensure the audio embedding dimension matches the LLM dimension.

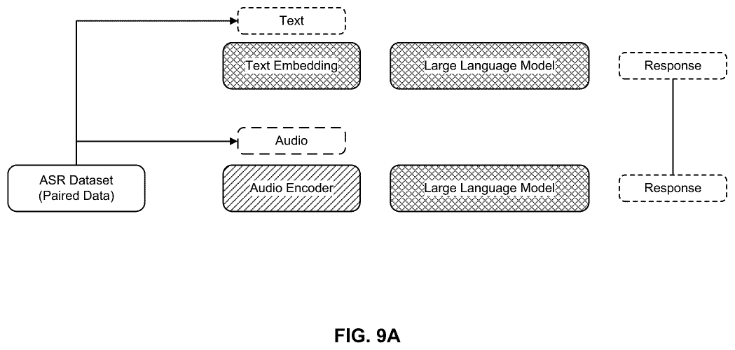

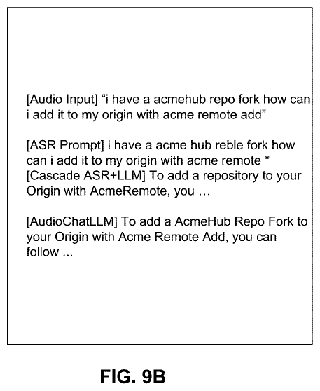

According to a further embodiment of this aspect, the subject technology as depicted in FIG. 9A illustrates a system architecture 900 with audio chat features. The system 900 may generate the same response irrespective of being fed spoken (e.g., audio) input or an equivalent text version thereof as shown by responses 960 and 970. In other words, the system is invariant to the modality of the inputs containing the same semantic information.

According to an embodiment of FIG. 9A, an ASR dataset 910 may be provided to at least one LLM (e.g., LLM 940 and/or 950) for initial training. The audio encoder 930 may also be trained based on the ASR dataset 910. In other words, no LoRa adaptors may be required. Only the audio encoder may be trained to map audio embeddings to a language embedding space. In addition, the LLM may be frozen and its chat capabilities may be preserved.

In an exemplary aspect, there may be general alignment of audio encoder 950 and the text embedding 920. The respective responses 960, 970 generated by the downstream LLMs 940, 950 are envisaged to be aligned with each other in accordance with the subject technology. That is, the audio prompt can induce the same response as a text response.

According to examples of this embodiment, a linear layer may be applied on top, which is used to pre-train the system using a CTC loss with a 1.5 k Sentence Piece vocabulary and is discarded after pre-training. These embeddings may be sandwiched between a prefix and suffix during the training phase. Such examples follow a chat prompting structure, wherein the system prompt has been set to be empty and the user prompt is replaced by the variable-length sequence of audio embeddings. Conditioned on this prompt, the system is trained to predict the next token of the previously generated response.

According to even a further embodiment as shown in FIG. 9B, a generated response from a LLM architecture with audio chat features is provided in the user interface 990. The user interface 990 provides results of evaluating the ability of the LLM in various settings. For example, an evaluation of responses to Trivia Q/A from the cascaded baseline and LLM are provided. The response quality may be comparing with reference answers. It was observed the cascaded baseline suffers more in providing reasonable responses when error rates from the ASR model are relatively high. In high error rate situations (37.5% and 14.3%), the proposed architecture of the subject technology generates better answers in comparison with the cascaded system baseline. Hence, the instant subject technology provides a robust end-to-end system with a lower error rate situation (4.3%) and performance on par with the baseline.

It is also observed that the instant LLM architecture may do better with rare words and named entities which may often be challenging for cascaded systems. For example, for rare words like Griffonage, the instant LLM may provide an accurate response whereas in a cascaded system it may be misrecognized and may impact the response from an LLM.

The performance of the proposed model with a baseline across datasets with different word error rate levels was studied. In high error rate situations (37.5% and 14.3%), the LLM model generated better answers in comparison with the baseline. Meanwhile, in lower error rate situation (4.3%), the performance was on par with the baseline. Three (3) different word error levels based on the baseline were compared. For each level, 50 question samples were selected to evaluate the generated answers. The success rate (SR) was used as a metric, measuring the fraction of predicted responses that agree with the reference response.

The perplexity results show that the instant LLM architecture outperforms the cascaded ASR+LLM systems on both MLS and TriviaQA-TTS data, all while not having to perform two stages of decoding. A further improvement of the instant LLM architecture is that it is able to maintain a dialogue and uses prior context to guide the response generation.

On both synthesized and recorded speech QA test sets, the evaluations indicate the instant approach is on par with or outperforms cascaded systems (speech recognizer+LLM) in terms of modelling the response to a prompt.

Table 1 below provides human evaluation success rate (SR) on Trivia QA:

TABLE 1

| Model | Prompt WER | Response SR |
|---|---|---|
| Cascade ASR + LLM | 37.5% | 40% |
| LLM | — | 52% |
| Cascade ASR + LLM | 14.3% | 60% |
| LLM | — | 70% |
| Cascade ASR + LLM | 4.3% | 80% |
| LLM | — | 80% |

### Spoken Question Answering Examples

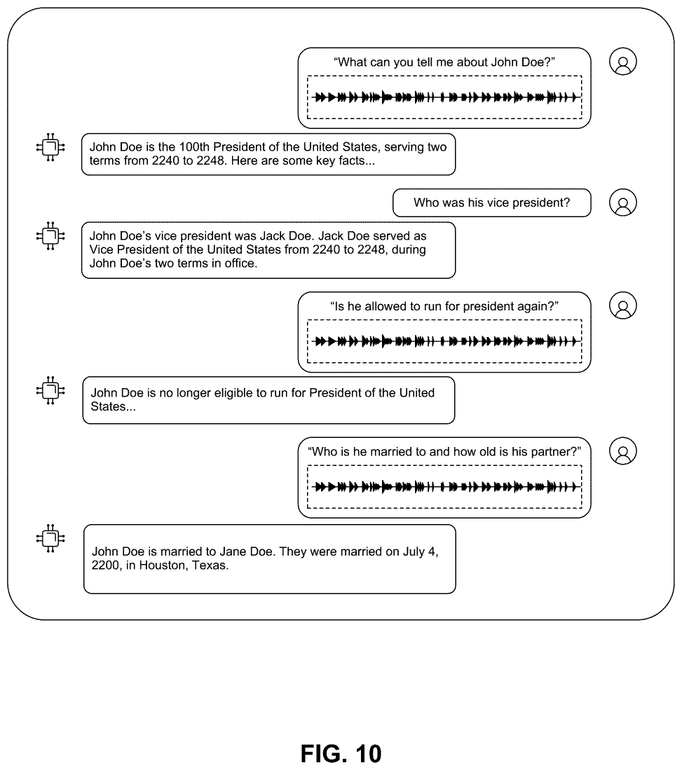

According to yet a further embodiment, a user interface 1000 as depicted in FIG. 10 provides a conversation history between a user and the system architecture. The conversation history in the user interface indicates a mixture of modalities (e.g., text and audio) for providing statements and/or questions. For example, the user provides a first statement via audio (e.g., “What can you tell me about John Doe?”). The system provides a textual response in accordance with the aforementioned subject technology (e.g., John Doe is the 100th President of the United States, serving two terms from 2240 to 2248. Here are some key facts.”). Subsequently, the user provides a second statement via text (e.g., “Who was his vice president?”). In turn, the system provides a textual response (e.g., “John Doe's vice president was Jack Doe. Jack Doe served as Vice President of the United States from 2240 to 2248, during John Doe's two terms in office.”).

### Model Architecture & Training

An audio encoder may be built and pre-trained based on a similar audio encoder that operates on 80-dimensional filter banks with a 10 millisecond (ms) frame rate. The architecture consists of a convolutional feature extractor with an output frame rate of 80 ms followed by a linear layer to project the output to 512 dimensions. This sequence of features is then fed through a number of conformer layers. Each conformer block has a hidden dimension of 512, a feed-forward net dimension of 2048, a kernel size of 11, and 8 attention heads. A linear layer is applied on top, which may be used to pre-train the system using a Connectionist CTC loss with a 1.5 k Sentence Piece vocabulary and is discarded after pre-training.

The encoder output is a sequence of 512-dimensional vectors with a frame rate of 80 ms. The system may reduce sequence length by stacking every n consecutive frames. These are then projected to 4096-d to match the secondary language model dimension, with a resulting frame rate of 80 nano milliseconds (nms). These embedding(s) may be sandwiched between a prefix and suffix which are set to the following during the training phase:
prefix=“<s>>[INST]<SYS>\n\n</SYS>\n\n”
suffix=“[/INST]”

Note that this simply follows the standard secondary language model prompting structure, where the system prompt has been set to be empty and the user prompt is replaced by the variable-length sequence of audio embeddings. Conditioned on this prompt, the system may be trained to predict the next token of the previously generated response.

It is envisaged to maintain all original capabilities of the instruction-tuned LLM and therefore it may be kept frozen in all experiments. A trainable aspect of the system is the audio encoder which makes up a fraction of all parameters. The secondary language model was purposely chosen for both data generation and training to ensure minimal mismatch.

Training: The audio encoders were initially pre-trained using Adam (herein Adam is a stochastic optimization method applied during neural network training) with β₁=0.9, β₂=0.98. The learning rate was warmed up over 20 k training steps up to a peak value of 1e-3 followed by an exponential decaying schedule. This was done on 40 gigabytes (GBs) chips with 4 gradient accumulations using a per-gpu (Graphics Processing Unit) batch size of up to 500 seconds of audio. The checkpoint with the best validation loss was picked. The joint system with an audio encoder and LLM was thereafter trained with a schedule of 5 k warmup steps up to a peak learning rate of 5e-4 decaying down to 5e-6 over 250 k steps. Training was often terminated within 100 k steps. This was performed on 40 GBs chips with 8 gradient accumulation steps using a batch size of 2. Decoding may be done using beam search with a beam of 10.

### Perplexity

The system first compared the perplexity of unsupervised response on the development set in Table 2. The proposed model achieved a better perplexity than the cascaded ASR+LLM system.

TABLE 2

| | Text-Prompt | Response |
|---|---|---|
| Model | WER | PPL |
| Reference text | 0% | 1.382 |
| Cascaded ASR + LLM | 8.9% | 1.571 |
| Proposed model | — | 1.544 |

### Embedding Space Analysis

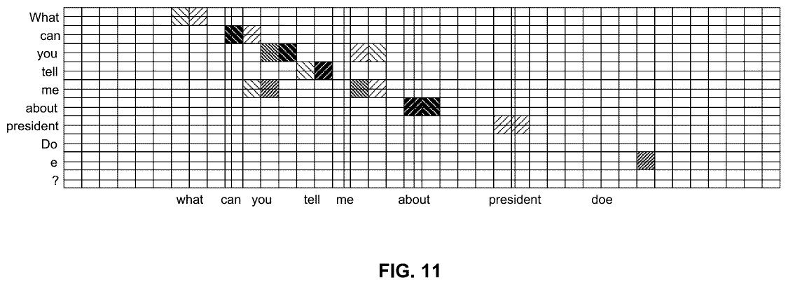

It is envisaged in the model that if the learned audio prompt embeddings are in the same semantic space as its text counterparts, the audio and text embeddings may be monotonically aligned for a properly trained system. The system may therefore compute the cosine similarity between each possible pair of audio and text embedding for an English test set example. This may be done for the proposed model to understand the impact of increased striding on the impact of alignment, as illustrated in FIG. 11. These alignment plots 1100 support the hypothesis that the encoder is attempting to align the audio embeddings to the text in a monotonic manner.

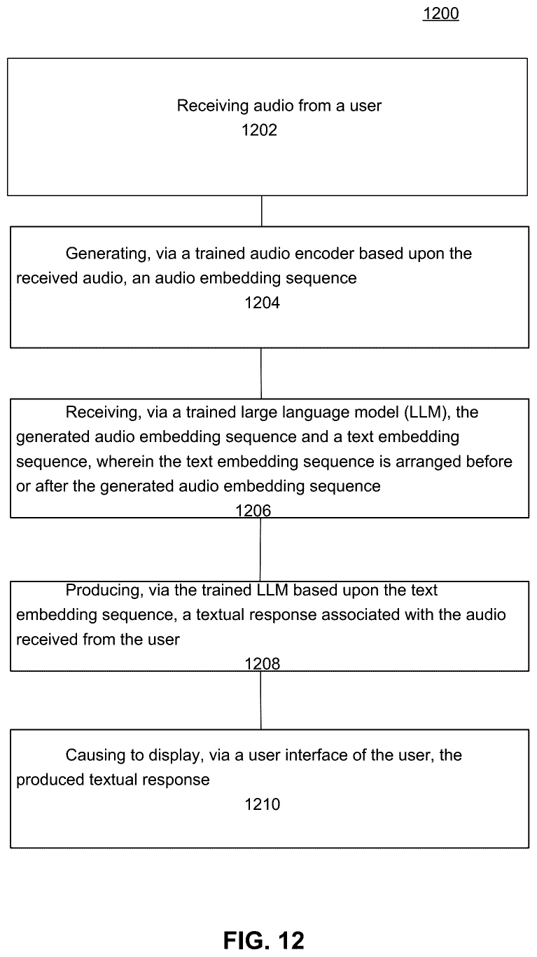

According to yet even another embodiment, FIG. 12 depicts a flowchart of an example process 1200. In some implementations, one or more process blocks of FIG. 12 may be performed by a device. As shown in FIG. 12, process 1200 may include a step of receiving audio from a user (block 1202). As further shown in FIG. 12, process 1200 may include a step of generating, via a trained encoder based upon the received audio, an audio embedding sequence (block 1204). As further shown in FIG. 12, process 1200 may include a step of receiving, via a trained large language model (LLM), the generated audio embedding sequence and a text embedding sequence, wherein the text embedding sequence is arranged before or after the generated audio embedding sequence (block 1206). As further shown in FIG. 12, process 1200 may include a step of producing, via the trained LLM based upon text embedding sequence, a textual response associated with the audio from the user (block 1208). As further shown in FIG. 12, process 1200 may include a step of causing to display, via a user interface of the user, the produced textual response (block 1210).

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving audio from a user;
generating, via a trained audio encoder based upon the received audio, an audio embedding sequence;
receiving, via a trained large language model (LLM), the generated audio embedding sequence and a text embedding sequence, wherein the text embedding sequence is arranged before or after the generated audio embedding sequence;
producing, via the trained LLM based upon the text embedding sequence, a textual response associated with the audio received from the user; and
causing to display, via a user interface of the user, the produced textual response.

2. The method of claim 1, wherein the text embedding sequence is arranged before and after the generated audio embedding sequence.

3. The method of claim 1, wherein the audio embedding sequence is devoid of an intermediate step of converting the audio embedding sequence into a textual representation.

4. The method of claim 1, wherein the audio embedding sequence is monotonically aligned with the text embedding sequence.

5. The method of claim 1, wherein the LLM uses the text embedding sequence to interpret the audio embedding sequence.

6. The method of claim 1, wherein the text embedding sequence includes a conversation history associated with the user.

7. The method of claim 1, further comprising:
receiving, via the trained audio encoder, supplemental audio from the user;
generating a supplemental audio embedding sequence; and
producing a supplemental textual response based upon the audio embedding sequence.

8. The method of claim 1, wherein the audio encoder is trained on a textual output of the LLM, and wherein the textual output is derived from automatic speech recognition (ASR) data.

9. The method of claim 8, wherein the ASR data includes audio data and labeled text associated with the audio data.

10. The method of claim 1, further comprising:
controlling, via the trained encoder, an audio resolution of the audio embedding sequence prior to being received by the LLM.

11. The method of claim 1, wherein the audio encoder includes a convolutional feature extractor with an output frame rate of 80 milliseconds.

12. A system comprising:
a non-transitory memory including instructions stored thereon; and
a processor operably coupled to the non-transitory memory and configured to execute the instructions of:
receiving audio from a user;
generating, via a trained audio encoder based upon the received audio, an audio embedding sequence;
receiving, via a trained large language model (LLM), the generated audio embedding sequence and a text embedding sequence, wherein the text embedding sequence is located before or after the generated audio embedding sequence;
producing, via the trained LLM based upon the text embedding sequence, a textual response associated with the audio received from the user; and
causing to display, via a user interface of the user, the produced textual response.

13. The system of claim 12, wherein the text embedding sequence is located before and after the audio embedding sequence.

14. The system of claim 12, wherein the audio embedding sequence is devoid of an intermediate step of converting the audio embedding sequence into a textual representation.

15. The system of claim 12, wherein the audio embedding sequence is monotonically aligned with the text embedding sequence.

16. The system of claim 12, wherein the LLM is configured to use the text embedding sequence to interpret the audio embedding sequence.

17. The system of claim 12, wherein the text embedding sequence includes a conversation history associated with the user.

18. The system of claim 12, wherein the processor is further configured to execute the instructions of:
receiving, via the trained audio encoder, supplemental audio from the user;
generating a supplemental audio embedding sequence; and
producing a supplemental textual response based upon the audio embedding sequence.

19. The system of claim 12, wherein the trained audio encoder is trained on a textual output of the LLM, and wherein the textual output is derived from automatic speech recognition (ASR) data.

20. A non-transitory computer-readable medium storing instructions that, when executed, cause:
receiving audio from a user;
generating, via a trained audio encoder based upon the received audio, an audio embedding sequence;
receiving, via a trained large language model (LLM), the generated audio embedding sequence and a text embedding sequence, wherein the text embedding sequence is arranged before or after the generated audio embedding sequence;
producing, via the trained LLM based upon the text embedding sequence, a textual response associated with the audio received from the user; and
causing to display, via a user interface of the user, the produced textual response.
